(19) United States
(12) Patent Application Publication
(10) Pub. No.: US 2013/0138419 A1
(43) Pub. Date: May 30, 2013

(54) METHOD AND SYSTEM FOR THE ASSESSMENT OF COMPUTER SYSTEM RELIABILITY USING QUANTITATIVE CUMULATIVE STRESS METRICS

(71) Applicants: Leoncio D. Lopez, Escondido, CA (US); Anton A. Bougaev, La Jolla, CA (US); Kenny C. Gross, San Diego, CA (US); David K. McElfresh, San Diego, CA (US); Alan P. Wood, San Jose, CA (US)

(72) Inventors: Leoncio D. Lopez, Escondido, CA (US); Anton A. Bougaev, La Jolla, CA (US); Kenny C. Gross, San Diego, CA (US); David K. McElfresh, San Diego, CA (US); Alan P. Wood, San Jose, CA (US)

(73) Assignee: ORACLE INTERNATIONAL CORPORATION, Redwood City, CA (US)

(21) Appl. No.: 13/307,327

(22) Filed: Nov. 30, 2011

(51) Int. Cl. G06F 9/44; G06F 11/00

(52) U.S. Cl. 703/21

(57) ABSTRACT

The disclosed embodiments provide a system that analyzes telemetry data from a computer system. During operation, the system obtains the telemetry data as a set of telemetric signals using a set of sensors in the computer system. Next, for each component or component location from a set of components in the computer system, the system applies an inferential model to the telemetry data to determine an operating environment of the component or component location, and uses the operating environment to assess a reliability of the component. Finally, the system manages use of the component in the computer system based on the assessed reliability.

### BACKGROUND

1. Field

The present embodiments relate to techniques for monitoring and analyzing computer systems. More specifically, the present embodiments relate to a method and system for performing reliability assessment of the computer systems using quantitative cumulative stress metrics for components in the computer systems.

2. Related Art

As electronic commerce becomes more prevalent, businesses are increasingly relying on enterprise computing systems to process ever-larger volumes of electronic transactions. A failure in one of these enterprise computing systems can be disastrous, potentially resulting in millions of dollars of lost business. More importantly, a failure can seriously undermine consumer confidence in a business, making customers less likely to purchase goods and services from the business. Hence, it is important to ensure reliability and/or high availability in such enterprise computing systems.

To assess the reliability of a system S corresponding to an individual electronic component, a field-replaceable unit (FRU), and/or an entire computer system, a remaining useful life (RUL) of the system may be calculated from the time-to-failure (TTF) and operating time t of the system using the following:

RUL(t)=TTF(t)−t

For simple mechanical components, TTF(t) is a random variable; thus, RUL(t) is also a random variable with a corresponding probability distribution. If the failure distribution of S were exponentially distributed, meaning that S's probability of failure is independent of the operating time t, then RUL(t) is also exponentially distributed, and the mean of RUL(t) is a constant that is also independent oft. This constant mean is typically called mean time between failures (MTBF). Such conventional MTBF formalism is relevant to components that experience no aging effects, and in turn, have failure probabilities that truly are independent of time.

However, a more complex system (e.g., enterprise computing system) has a time-dependent failure distribution, with the probability of failure increasing as a function of time due to wear-out mechanisms and cumulative stress. In such a system, RUL(t) is also time dependent, with a mean that decreases as a function of t. Consequently, accurate prediction of RUL(t) may facilitate the proactive replacement of components, assemblies, or systems, eliminating or reducing down time resulting from system failures.

Three techniques are commonly used to estimate the RUL(t) probability distribution for conventional mechanical (e.g., non-electronic) assets. The first uses reliability predictions, usually based on component field or test data, to determine the failure distribution (e.g., MTBF) of an average component in the expected usage environment. The RUL(t) prediction then assumes all components and the usage environment are average.

A second technique, called damage-based RUL(t) prediction, is to directly measure or infer the damage or wear on the system and/or its constituent components. For example, it may be possible to infer the atomic changes to an electronic component's silicon crystal lattice structure from measurements of the component's timing delay. The RUL(t) probability distribution is then based on the accumulated damage and rate at which damage is occurring. This technique is much more accurate than MTBF-based RUL(t) prediction but is only applicable to a very limited set of components due to the large number of sensors required for performing damage-based RUL(t) prediction.

The above two techniques for RUL(t) estimation of mechanical assets have been applied with limited success in the field of computing systems. The reasons that success has been limited for the two foregoing approaches to RUL(t) estimation are:
(1) tracking empirical failure rates for populations of servers (like actuarial statistics for humans) will produce average “life expectancy” estimates for systems in the field but cannot identify degradation acceleration factors that individual systems experience in a variety of operating environments; and
(2) to apply damage-based RUL(t) estimation, dense sensor networks are required to track the damage mechanisms, which may be economically feasible for safety-critical applications but not for enterprise computing systems.

A third and completely different approach is called stress-based RUL(t) prediction (e.g., physics-of-failure). For conventional mechanical assets, stress-based RUL(t) prediction is useful when it is not possible or feasible to measure parameters such as circuit timing that directly relate to the accumulated damage, but it is possible to measure operating environment parameters that have known relationships with component damage models. For example, it may be possible to measure the temperature and voltage cycles in a circuit environment and use equations to calculate RUL(t) from the temperature and voltage cycles, or infer mechanical stress on solder joints from vibration measurements. The RUL(t) probability distribution is then based on the accumulated damage expected to have occurred due to the operating environment. This prediction technique can illuminate the onset of many failure mechanisms that would not otherwise trip a threshold value or cause any change to measured parameters.

The main barrier to the implementation of a stress-based RUL(t) prediction technique for enterprise computing systems and/or other electronic systems is the lack of operating environment data at the component level. Modern data centers are composed of dozens (or hundreds or thousands) of computer systems, each with thousands of active and passive electronic components. The local operating environment of each of these components is a function of temperature and humidity in the data center, internal system temperature and vibration, component power dissipation, airflow, and component thermal characteristics, among others. Because of the thermal dissipation characteristics of each component, spatial thermal gradients exist across the components' surfaces. Such variations in operating environment result in “unique” operating profiles, even among identical components within the same computer system. Due to system bus limitations on computer systems, it is not practical to have environmental sensors continuously measuring all environmental parameters at all component locations. Moreover, such measurement would generate an enormous amount of data to store and analyze.

Hence, what is needed is a mechanism for enabling accurate reliability assessment of components in enterprise computing systems and/or other electronic systems.

### SUMMARY

The disclosed embodiments provide a system that analyzes telemetry data from a computer system. During operation, the system obtains the telemetry data as a set of telemetric signals using a set of sensors in the computer system. Next, for each component or component location from a set of components in the computer system, the system applies an inferential model to the telemetry data to determine an operating environment of the component or component location, and uses the operating environment to assess a reliability of the component. Finally, the system manages use of the component in the computer system based on the assessed reliability.

In some embodiments, the system also uses the operating environment to assess the reliabilities of at least one of a field-replaceable unit (FRU) containing the component, the computer system, and a set of computer systems containing the computer system or FRU.

In some embodiments, the inferential model is created by:
(i) using a set of reference sensors to monitor a reference operating environment for a reference component in a test system, wherein the reference component corresponds to the component in the computer system;
(ii) stress-testing the test system over an operating envelope of the computer system; and
(iii) using a regression technique to develop the inferential model from the monitored reference operating environment.

In some embodiments, using the operating environment to assess the reliability of the component involves:
(i) obtaining the operating environment as a set of stress metrics for the component;
(ii) adding the stress metrics to a cumulative stress history for the component; and
(iii) calculating a remaining useful life (RUL) of the component using the cumulative stress history.

In some embodiments, the stress metrics include at least one of a temperature, a temperature derivative with respect to time, a vibration level, a humidity, a current, a current derivative with respect to time, and a voltage.

In some embodiments, managing use of the component based on the assessed reliability involves at least one of generating an alert if the RUL drops below a threshold, and using the assessed reliability to facilitate a maintenance decision associated with the component. For example, the assessed reliability may be used to identify weak and/or compromised components in an assembly, system or data center.

In some embodiments, the reliability of the component is assessed using at least one of a processor on the computer system, a loghost computer system in a data center containing the computer system, and a remote monitoring center for a set of data centers.

In some embodiments, the telemetric signals are further obtained using at least one of an operating system for the computer system and one or more external sensors.

### BRIEF DESCRIPTION OF THE FIGURES

FIG. 1 shows a computer system which includes a service processor for processing telemetry signals in accordance with the disclosed embodiments.

FIG. 2 shows a telemetry analysis system which examines both short-term real-time telemetry data and long-term historical telemetry data in accordance with the disclosed embodiments.

FIG. 3 shows a flowchart illustrating the process of analyzing telemetry data from a computer system in accordance with the disclosed embodiments.

FIG. 4 shows a flowchart illustrating the process of creating an inferential model for determining the operating environment of a component in accordance with the disclosed embodiments.

FIG. 5 shows a flowchart illustrating the process of using the operating environment of a component to assess the reliability of the component in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for analyzing telemetry data from a computer system. The telemetry data may be obtained from an operating system of the computer system, a set of sensors in the computer system, and/or one or more external sensors that reside outside the computer system.

More specifically, the disclosed embodiments provide a method and system for performing reliability assessment of components in the computer system using quantitative cumulative stress metrics for the components. For each monitored component or component location in the computer system, an inferential model is applied to the telemetry data to determine an operating environment of the component or the component location. The operating environment may include a set of stress metrics for the component, such as the component's temperature, temperature derivative with respect to time, vibration level, humidity, current, current derivative with respect to time, and/or voltage.

Next, the operating environment is used to assess the reliability of the component. The component's reliability may be assessed by adding the stress metrics to a cumulative stress history for the component and calculating a remaining useful life (RUL) of the component using the cumulative stress history. Finally, use of the component in the computer system is managed based on the assessed reliability. For example, an alert may be generated if the RUL drops below a threshold. Similarly, the assessed reliability may be used to facilitate a maintenance decision associated with a failure in the component by differentiating between weakness and stress in the component. Consequently, the disclosed embodiments may perform stress-based RUL prediction for components in computer systems with limited sensor coverage by inferring the components' operating environments from available telemetry data collected by sensors in and around the computer systems.

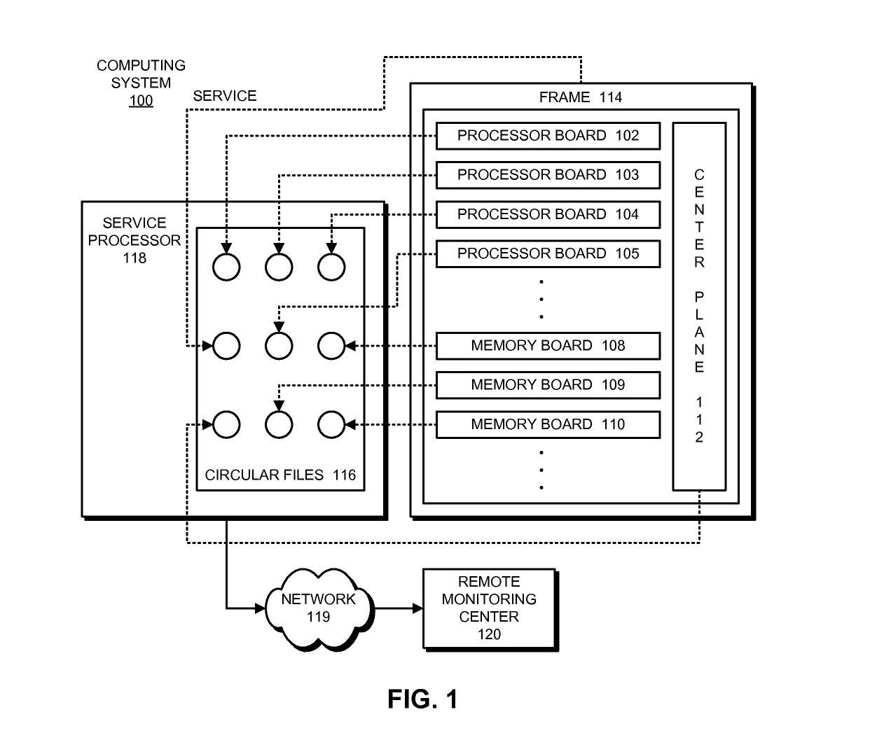

FIG. 1 shows a computer system which includes a service processor for processing telemetry signals in accordance with an embodiment. As is illustrated in FIG. 1, computer system 100 includes a number of processor boards 102-105 and a number of memory boards 108-110, which communicate with each other through center plane 112. These system components are all housed within a frame 114.

In one or more embodiments, these system components and frame 114 are all “field-replaceable units” (FRUs), which are independently monitored as is described below. Note that all major system units, including both hardware and software, can be decomposed into FRUs. For example, a software FRU can include an operating system, a middleware component, a database, and/or an application.

Computer system 100 is associated with a service processor 118, which can be located within computer system 100, or alternatively can be located in a standalone unit separate from computer system 100. For example, service processor 118 may correspond to a portable computing device, such as a mobile phone, laptop computer, personal digital assistant (PDA), and/or portable media player. Service processor 118 may include a monitoring mechanism that performs a number of diagnostic functions for computer system 100. One of these diagnostic functions involves recording performance parameters from the various FRUs within computer system 100 into a set of circular files 116 located within service processor 118. In one embodiment of the present invention, the performance parameters are recorded from telemetry signals generated from hardware sensors and software monitors within computer system 100. In one or more embodiments, a dedicated circular file is created and used for each FRU within computer system 100. Alternatively, a single comprehensive circular file may be created and used to aggregate performance data for all FRUs within computer system 100.

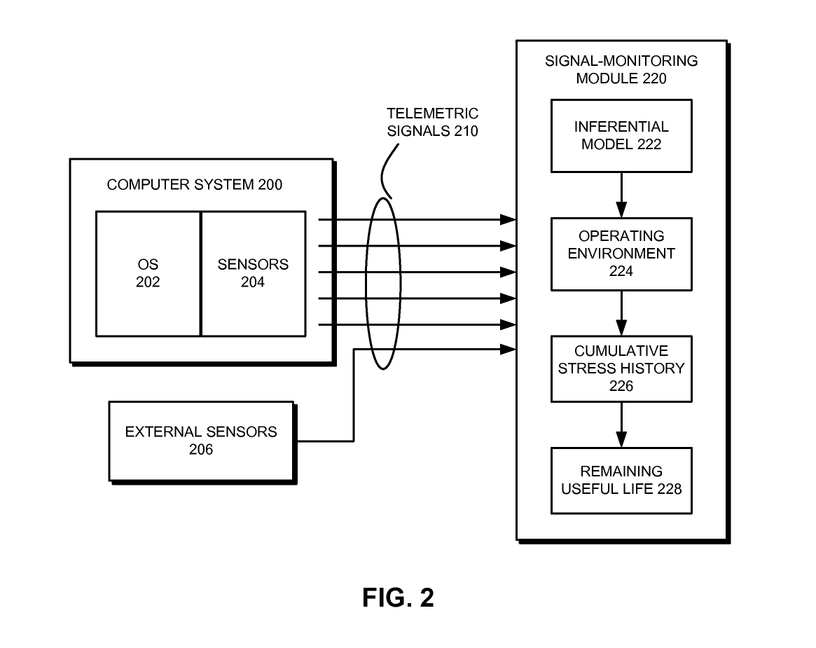

The contents of one or more of these circular files 116 can be transferred across network 119 to remote monitoring center 120 for diagnostic purposes. Network 119 can generally include any type of wired or wireless communication channel capable of coupling together computing nodes. This includes, but is not limited to, a local area network (LAN), a wide area network (WAN), a wireless network, and/or a combination of networks. In one or more embodiments, network 119 includes the Internet. Upon receiving one or more circular files 116, remote monitoring center 120 may perform various diagnostic functions on computer system 100, as described below with respect to FIG. 2. The system of FIG. 1 is described further in U.S. Pat. No. 7,020,802 (issued Mar. 28, 2006), by inventors Kenny C. Gross and Larry G. Votta, Jr., entitled “Method and Apparatus for Monitoring and Recording Computer System Performance Parameters,” which is incorporated herein by reference.

FIG. 2 shows a telemetry analysis system which examines both short-term real-time telemetry data and long-term historical telemetry data in accordance with the disclosed embodiments. In this example, a computer system 200 is monitored using a number of telemetric signals 210, which are transmitted to a signal-monitoring module 220. Signal-monitoring module 220 may assess the state of computer system 200 using telemetric signals 210. For example, signal-monitoring module 220 may analyze telemetric signals 210 to detect and manage faults in computer system 200 and/or issue alerts when there is an anomaly or degradation risk in computer system 200.

Moreover, signal-monitoring module 220 may include functionality to analyze both real-time telemetric signals 210 and long-term historical telemetry data. For example, signal-monitoring module 220 may be used to detect anomalies in telemetric signals 210 received directly from one or more monitored computer system(s) (e.g., computer system 200). Signal-monitoring module 220 may also be used in offline detection of anomalies from the monitored computer system(s) by processing archived and/or compressed telemetry data associated with the monitored computer system(s), such as from circular files 116 of FIG. 1.

Those skilled in the art will appreciate that the reliability and/or time-to-failure (TTF) of a component (e.g., processor, memory module, HDD, power supply, printed circuit board (PCB), integrated circuit, network card, computer fan, chassis, etc.) in computer system 200 may be significantly influenced by the operating environment (e.g., operating environment 224) of the component. Temperature, for example, may exacerbate reliability issues, as hot spots and thermal cycling increase failure rates during component lifetimes. Temperature gradients may also affect failure mechanisms in computer system 200. As feature sizes shrink, spatial temperature variations may cause a number of problems including timing failures due to variable delay, issues in clock tree design, and performance challenges. Global clock networks on chips are especially vulnerable to spatial variations as they reach throughout the die. Local resistances tend to scale linearly with temperature, so increasing temperature increases circuit delays and voltage (e.g., IR) drop.

Effects of temporal gradients may include solder fatigue, interconnect fretting, differential thermal expansion between bonded materials leading to delamination failures, thermal mismatches between mating surfaces, differential in the coefficients of thermal expansion between packaging materials, wirebond shear and flexure fatigue, passivation cracking, and/or electromigration failures. Temperature fluctuations may further result in electrolytic corrosion; thermomigration failures; crack initiation and propagation; delamination between chip dies, molding compounds, and/or leadframes; die de-adhesion fatigue; repeated stress reversals in brackets leading to dislocations, cracks, and eventual mechanical failures; and/or deterioration of connectors through elastomeric stress relaxation in polymers.

Voltage, especially in combination with thermal cycling, may accelerate failure mechanisms that manifest as atomic changes to the component silicon crystal lattice structure. Examples of these failure mechanisms include dielectric breakdown, hot carrier injection, negative bias temperature instability, surface inversion, localized charge trapping, and/or various forms of electro-chemical migration. Humidity, in combination with voltage and/or temperature, may accelerate electro-chemical migration rates and/or corrosion leading to failure modes such as dielectric breakdown, metal migration, shorts, opens, etc.

Similarly, vibration levels may accelerate a variety of wear-out mechanisms inside servers, especially mechanical wear-out such as cracking and fatigue. Vibration-related degradation may be exacerbated by vibration levels that increase with the rotation speeds of computer fans, blowers, air conditioning (AC) fans, power supply fans, and/or hard disk drive (HDD) spindle motors. At the same time, eco-efficiency best practices for data centers may call for locating AC equipment as close as possible to computer system 200 and/or other heat sources. For example, gross vibration levels experienced by computer system 200 increase sharply as vibrating AC modules are bolted onto the top and sides of a server rack in which computer system 200 is housed.

Those skilled in the art will also appreciate that conventional reliability assessment of computer system 200 may calculate a mean time between failures (MTBF) for computer system 200 by estimating and combining MTBFs for components in computer system 200. However, such MTBF-based approaches may assign the same MTBF estimate to a brand new component and an aged component. In addition, two components of the same age will have the same MTBF estimates, even if the first component experiences only cool temperatures with mild dynamic variations and the second component continually operates in a very warm server with aggressive load (and thermal) dynamics. Consequently, reliability assessment that is based on MTBFs of components in computer system 200 may produce an average “life expectancy” estimate for computer system 200 but cannot account for degradation acceleration factors of stressful operating environments in which the components of computer system 200 may operate.

In one or more embodiments, signal-monitoring module 220 includes functionality to perform accurate reliability assessment of computer system 200 using telemetric signals 210 collected from an operating system (OS) 202 of computer system 200, sensors 204 in computer system 200, and/or external sensors 206 that reside outside computer system 200. Telemetric signals 210 may correspond to load metrics, CPU utilizations, idle times, memory utilizations, disk activity, transaction latencies, temperatures, voltages, fan speeds, and/or currents. In addition, telemetric signals 210 may be collected at a rate that is based on the bandwidth of the system bus on computer system 200. For example, an Inter-Integrated Circuit (I²C) system bus on computer system 200 may allow telemetric signals 210 from a few hundred to a few thousand sensors to be updated every 5-30 seconds, with the sampling rate of each sensor inversely proportional to the number of sensors in computer system 200.

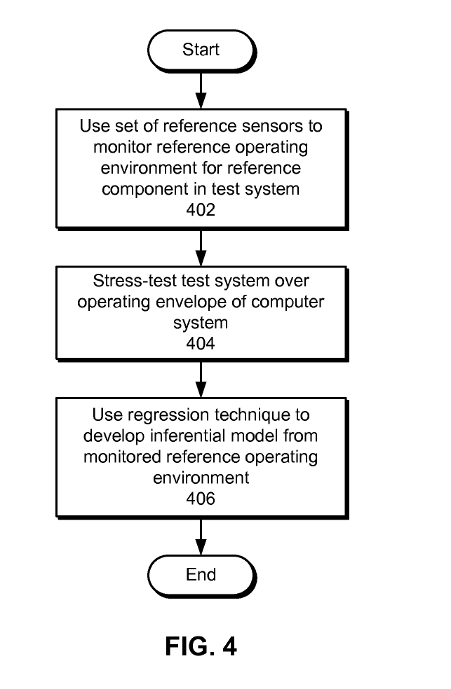

After telemetric signals 210 are transmitted to signal-monitoring module 220, signal-monitoring module 220 may apply an inferential model 222 to telemetric signals 210 to determine an operating environment 224 of each monitored (e.g., critical) component or component location in computer system 200. Inferential model 222 may be generated from telemetric signals obtained from a test system of the same platform as computer system 200. Creation of inferential model 222 is discussed in further detail below with respect to FIG. 4.

More specifically, signal-monitoring module 220 may use telemetric signals 210 and inferential model 222 to compute a set of stress metrics corresponding to the component's or component location's operating environment 224. The stress metrics may include a temperature, a temperature derivative with respect to time, a vibration level, a humidity, a current, a current derivative with respect to time, and/or a voltage of the component. In other words, signal-monitoring module 220 may analyze telemetric signals 210 from sparsely spaced sensors in and around computer system 200 to obtain a set of specific operating conditions (e.g., stress metrics) for the component or component location.

Next, signal-monitoring module 220 may use operating environment 224 to assess the reliability of the component or component location. As shown in FIG. 2, signal-monitoring module 220 may add the computed stress metrics from operating environment 224 to a cumulative stress history 226 for the component or component location. Signal-monitoring module 220 may then calculate a remaining useful life (RUL) 228 of the component using cumulative stress history 226. For example, signal-monitoring module 220 may use reliability failure models for various failure mechanisms described above to calculate one or more times to failure (TTFs) for the component from stress metrics tracked in cumulative stress history 226. Signal-monitoring module 220 may then calculate one or more values of RUL 228 by subtracting the component's operating time from each of the TTFs.

Finally, signal-monitoring module 220 may manage use of the component in computer system 200 based on the assessed reliability. For example, signal-monitoring module 220 may generate an alert if a value of RUL 228 drops below a threshold to identify an elevated risk of failure in the component. Signal-monitoring module 220 may also use the assessed reliability to facilitate a maintenance decision associated with the component. Continuing with the above example, the alert may be used to prioritize replacement of the component and prevent a failure in computer system 200, thus improving the reliability and availability of computer system 200 while decreasing maintenance costs associated with computer system 200. Alternatively, signal-monitoring module 220 may use cumulative stress history 226 and/or RUL 228 to attribute a failure in computer system 200 to either a weak component or a stressed component, FRU, and/or computer system 200. An administrator may then choose to remove the component and/or FRU, replace the component and/or FRU, or throw away computer system 200 based on the cause of failure determined by signal-monitoring module 220.

Signal-monitoring module 220 may additionally use operating environment 224 to assess the reliabilities of an FRU containing the component, computer system 200, and/or a set of computer systems (e.g., in a data center) containing computer system 200. For example, signal-monitoring module 220 may assess the reliability of the FRU based on the reliabilities of the components within the FRU, the reliability of computer system 200 based on the components and/or FRUs in computer system 200, and the reliability of the data center based on the reliabilities of the computer systems in the data center. Such reliability assessment and comparison at different granularities may facilitate the diagnosis of faults and/or failures in and/or among the components, FRUs, computer systems, or data center. For example, signal-monitoring module 220 may analyze a failure in a component by examining and comparing the cumulative stress histories and/or RULs of the component, systems (e.g., FRUs, computer systems, racks, data centers, etc.) containing the component, and/or similar components and/or systems.

By using inferential model 222 to identify specific operating conditions of components in computer system 200 from telemetric signals 210, signal-monitoring module 220 may increase the accuracy of RUL predictions for the components and/or computer system 200. In turn, the increased accuracy and/or resolution may enable the generation of proactive alarms for degraded and/or high-risk components, thus facilitating preventive replacements and/or other maintenance decisions and increasing the reliability and availability of computer system 200. The determination of operating environments in component locations without sensors may additionally allow potentially damaging conditions such as high temperature or vibration to be detected without the associated cost and/or complexity of adding sensors to the interior of computer system 200.

Those skilled in the art will appreciate that the system of FIG. 2 may be implemented in a variety of ways. First, all data collection and RUL computations may be performed directly on the monitored computer system 200. For example, signal-monitoring module 220 may be provided by and/or implemented using a service processor on computer system 200. In addition, the service processor may be operated from a continuous power line that is not interrupted when computer system 200 is powered off. Alternatively, if computer system 200 does not include a service processor, RUL estimation may be performed as a background daemon process on any CPU in computer system 200.

Second, signal-monitoring module 220 may be provided by a loghost computer system that accumulates and/or analyzes log files for computer system 200 and/or other computer systems in a data center. For example, the loghost computer system may correspond to a small server that collects operating system and/or error logs for all computer systems in the data center and performs reliability assessment of the computer systems using data from the logs. Use of the loghost computer system to implement signal-monitoring module 220 may allow all diagnostics, prognostics, and/or telemetric signals (e.g., telemetric signals 210) for any computer system (e.g., server) in the data center to be available at any time, even in situations where the computer system of interest has crashed.

Finally, signal-monitoring module 220 may reside within a remote monitoring center for multiple data centers (e.g., remote monitoring center 120 of FIG. 1). Telemetric signals 210 and/or telemetric signals for other computer systems in the data centers may be obtained by the remote monitoring center through a remote monitoring architecture connecting the data centers and the remote monitoring center. Such a configuration may enable proactive sparing logistics and replacement of at-risk FRUs before failures occur in the data centers. Conversely, if computer system 200 is used to process sensitive information and/or operates under stringent administrative rules that restrict the transmission of any data beyond the data center firewall, processing of telemetric signals 210 may be performed by computer system 200 and/or the loghost computer system.

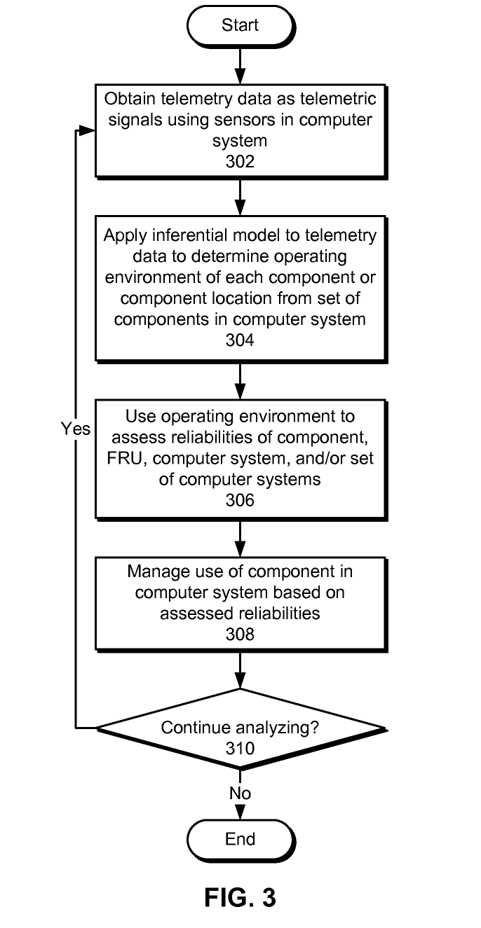

FIG. 3 shows a flowchart illustrating the process of analyzing telemetry data from a computer system in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, the telemetry data is obtained as a set of telemetric signals using a set of sensors in the computer system (operation 302). The telemetric signals may include load metrics, CPU utilizations, idle times, memory utilizations, disk activity, transaction latencies, temperatures, voltages, fan speeds, and/or currents. The telemetric signals may be obtained and/or analyzed by a service processor in the computer system, a loghost computer system in a data center containing the computer system, and/or a remote monitoring center for a set of data centers.

Next, an inferential model is applied to the telemetry data to determine an operating environment of each component from a set of components (e.g., monitored components) in the computer system (operation 304). For example, the operating environment may be determined periodically and/or upon request for each critical component in the computer system.

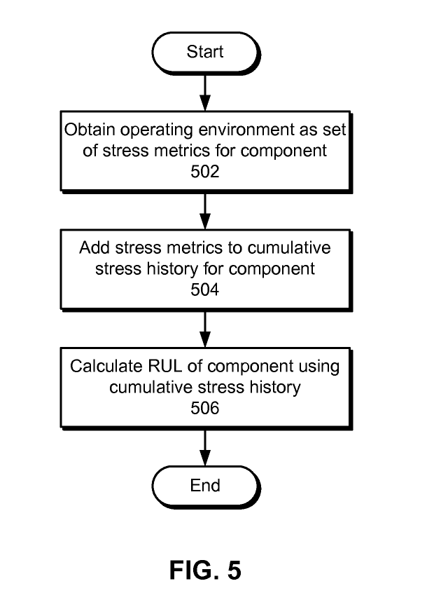

The operating environment is then used to assess the reliabilities of the component, an FRU containing the component, the computer system, and/or a set of computer systems containing the computer system (operation 306). For example, the operating environment may be used to calculate an RUL for the component, FRU, computer system, or data center containing the computer system, as discussed in further detail below with respect to FIG. 5.

Finally, use of the component in the computer system is managed based on the assessed reliability (operation 308). For example, an alert may be generated if the RUL drops below a threshold to identify an elevated risk of failure in the component. Similarly, the assessed reliability may be used to facilitate a maintenance decision associated with the component.

Analysis of the telemetry data may continue (operation 310). For example, the telemetry data may be analyzed for each monitored component in the computer system. If analysis of the telemetry data is to continue, the telemetry data is obtained as a set of telemetric signals (operation 302), and an operating environment is determined from the telemetry data for each monitored component in the computer system (operation 304). The operating environment is used to assess the reliabilities of the component and/or more complex systems containing the component (operation 306), and use of the component is managed based on the assessed reliabilities (operation 308). Reliability assessment of the components and maintenance of the computer system based on the reliability assessment may continue until execution of the computer system ceases.

FIG. 4 shows a flowchart illustrating the process of creating an inferential model for determining the operating environment of a component in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

First, a set of reference sensors is used to monitor a reference operating environment for a reference component in a test system (operation 402). The reference component may be of the same platform as the component, and the test system may be of the same platform as that of a computer system containing the component. The reference sensors may be strategically located to capture the reference component's reference operating environment, as well as the reference operating environments of other critical reference components in the test system. In addition, sensors may be placed outside the test system to monitor the ambient temperature and relative humidity, and system level variables that are relevant to the component's operating environment may be identified. Note that the sensors may be temporary in nature, in that the sensors are used specifically to create the model and not included in the computer system.

Next, the test system is stress-tested over the operating envelope of the computer system (operation 404). For example, the test system may be subjected to all combinations of temperature, humidity, and/or vibration conditions expected for the computer system's operating envelope.

Finally, a regression technique is used to develop the inferential model from the monitored reference operating environment (operation 406). The regression technique may correspond to a linear, non-linear, parametric, and/or non-parametric regression technique. For example, the regression technique may utilize the least squares method, quantile regression, and/or maximum likelihood estimates. Similarly, the parametric regression technique may include Weibull, exponential, lognormal, and/or other types of probability distributions.

In one or more embodiments, the regression technique corresponds to a multivariate state estimation technique (MSET). The MSET technique may correlate stress factors from the reference operating environment with sensor readings and/or failure rates in the computer system. The MSET technique may also identify the minimum number of “key” variables needed to infer the operating environment for the component at the component's location.

In one or more embodiments, the regression technique used to create the inferential model may refer to any number of pattern recognition algorithms. For example, see [Gribok] “Use of Kernel Based Techniques for Sensor Validation in Nuclear Power Plants,” by Andrei V. Gribok, J. Wesley Hines, and Robert E. Uhrig, The Third American Nuclear Society International Topical Meeting on Nuclear Plant Instrumentation and Control and Human-Machine Interface Technologies, Washington D.C., Nov. 13-17, 2000. This paper outlines several different pattern recognition approaches. Hence, the term “MSET” as used in this specification can refer to (among other things) any techniques outlined in [Gribok], including Ordinary Least Squares (OLS), Support Vector Machines (SVM), Artificial Neural Networks (ANNs), MSET, or Regularized MSET (RMSET).

In addition, the inferential model may be created using an R-function technique. Use of an R-function technique to create an inferential model is discussed in U.S. Pat. No. 7,660,775 (issued 9 Feb. 2010), by inventors Anton A. Bougaev and Aleksey M. Urmanov, entitled “Method and Apparatus for Classifying Data Using R-Functions”; and in U.S. Pat. No. 7,478,075 (issued 13 Jan. 2009), by inventors Aleksey M. Urmanov, Anton A. Bougaev, and Kenny C. Gross, entitled “Reducing the Size of a Training Set for Classification,” which are incorporated herein by reference.

The inferential model may then be used during the operation of computer systems with the same configuration and components as the test system. For example, each computer system may collect and store the “key” variables identified as necessary for the calculation of component operating environments. The inferential model may reside on the computer system and/or in another location (e.g., loghost computer system, remote monitoring center). Component operating environments, cumulative stress histories, and/or RULs based on the operating environments may then be calculated on the computer system or at another location, either proactively as a monitor on server reliability or in response to requests. The operating environments, cumulative stress histories, and/or RULs may be recreated each time or stored and updated depending on the availability of compute and storage resources.

FIG. 5 shows a flowchart illustrating the process of using the operating environment of a component to assess the reliability of the component in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

First, the operating environment is obtained as a set of stress metrics for the component (operation 502). The stress metrics may include a temperature, a temperature derivative with respect to time, a vibration level, a humidity, a current, a current derivative with respect to time, and/or a voltage for the component. Next, the stress metrics are added to a cumulative stress history for the component (operation 504). The cumulative stress history may track the operational history of the component with respect to the stress metrics. Finally, the RUL of the component is calculated using the cumulative stress history (operation 506). For example, the cumulative stress history may be used to calculate a TTF for a failure mechanism associated with the component, and the RUL may be obtained by subtracting the component's operating time from the TTF.

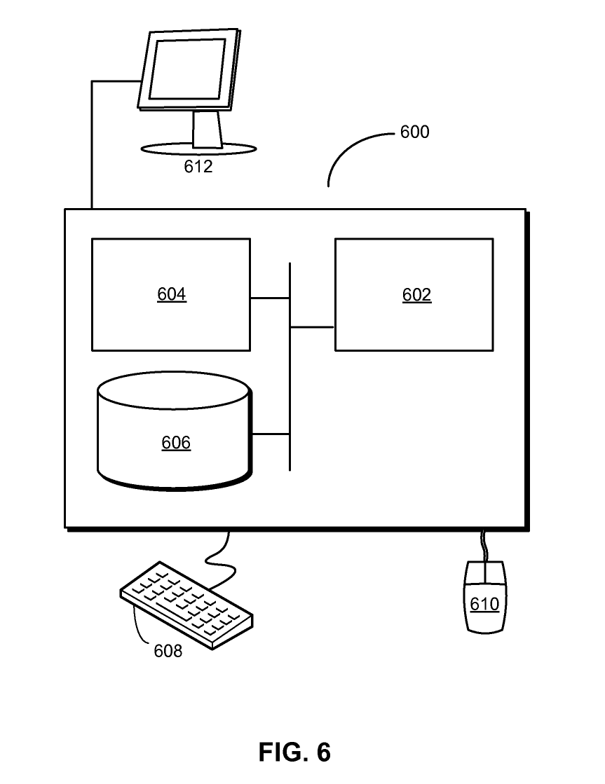

FIG. 6 shows a computer system 600. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an OS (not shown) that coordinates the use of hardware and software resources on computer system 600, as well as one or more applications that perform specialized tasks for the user. To perform tasks for the user, applications may obtain the use of hardware resources on computer system 600 from the OS, as well as interact with the user through a hardware and/or software framework provided by the OS.

In particular, computer system 600 may implement a signal-monitoring module that analyzes telemetry data from a computer system. The signal-monitoring module may apply an inferential model to the telemetry data to determine an operating environment of a component in the computer system. The signal-monitoring module may also use the operating environment to assess a reliability of the component. The signal-monitoring module may then manage use of the component in the computer system based on the assessed reliability. The signal-monitoring module may additionally use the operating environment to assess the reliabilities of at least one of an FRU containing the component, the computer system, and a data center containing the computer system.

In addition, one or more components of computer system 600 may be remotely located and connected to the other components over a network. Portions of the present embodiments (e.g., monitoring mechanism, signal-monitoring module, etc.) may also be located on different nodes of a distributed system that implements the embodiments. For example, the present embodiments may be implemented using a cloud computing system that provides a remote monitoring and analysis framework for computer servers in multiple data center locations.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for analyzing telemetry data from a computer system, comprising:
obtaining the telemetry data as a set of telemetric signals using a set of sensors in the computer system; and
for each component or component location from a set of components in the computer system:
applying an inferential model to the telemetry data to determine an operating environment of the component or component location;
using the operating environment to assess a reliability of the component; and
managing use of the component in the computer system based on the assessed reliability.

2. The computer-implemented method of claim 1, further comprising:
further using the operating environment to assess the reliabilities of at least one of a field-replaceable unit (FRU) containing the component, the computer system, and a set of computer systems containing the computer system or FRU.

3. The computer-implemented method of claim 1, wherein the inferential model is created by:
using a set of reference sensors to monitor a reference operating environment for a reference component in a test system, wherein the reference component corresponds to the component in the computer system;
stress-testing the test system over an operating envelope of the computer system; and
using a regression technique to develop the inferential model from the monitored reference operating environment.

4. The computer-implemented method of claim 1, wherein using the operating environment to assess the reliability of the component involves:
obtaining the operating environment as a set of stress metrics for the component;
adding the stress metrics to a cumulative stress history for the component; and
calculating a remaining useful life (RUL) of the component using the cumulative stress history.

5. The computer-implemented method of claim 4, wherein the stress metrics comprise at least one of a temperature, a temperature derivative with respect to time, a vibration level, a humidity, a current, a current derivative with respect to time, and a voltage.

6. The computer-implemented method of claim 4, wherein managing use of the component based on the assessed reliability involves at least one of:
generating an alert if the RUL drops below a threshold; and
using the assessed reliability to facilitate a maintenance decision associated with the component.

7. The computer-implemented method of claim 1, wherein the reliability of the component is assessed using at least one of:
a processor on the computer system;
a loghost computer system in a data center containing the computer system; and
a remote monitoring center for a set of data centers.

8. The computer-implemented method of claim 1, wherein the telemetric signals are further obtained using at least one of an operating system for the computer system and one or more external sensors.

9. The computer-implemented method of claim 1, wherein the telemetric signals comprise at least one of:
a load metric;
a CPU utilization;
an idle time;
a memory utilization;
a disk activity;
a transaction latency;
a temperature;
a voltage;
a fan speed; and
a current.

10. A system for analyzing telemetry data from a computer system, comprising:
a monitoring mechanism configured to obtain the telemetry data as a set of telemetric signals using a set of sensors in the computer system; and
a signal-monitoring module configured to:
for each component or component location from a set of components in the computer system:
apply an inferential model to the telemetry data to determine an operating environment of the component or component location;
use the operating environment to assess a reliability of the component; and
manage use of the component in the computer system based on the assessed reliability.

11. The system of claim 10, wherein the management apparatus is further configured to:
use the operating environment to assess the reliabilities of at least one of a field-replaceable unit (FRU) containing the component, the computer system, and a set of computer systems containing the computer system or FRU.

12. The system of claim 10, wherein using the operating environment to assess the reliability of the component involves:
obtaining the operating environment as a set of stress metrics for the component;
adding the stress metrics to a cumulative stress history for the component; and
calculating a remaining useful life (RUL) of the component using the cumulative stress history.

13. The system of claim 12, wherein the stress metrics comprise at least one of a temperature, a temperature derivative with respect to time, a vibration level, a humidity, a current, a current derivative with respect to time, and a voltage.

14. The system of claim 12, wherein managing use of the component based on the assessed reliability involves at least one of:
generating an alert if the RUL drops below a threshold; and
using the assessed reliability to facilitate a maintenance decision associated with the component.

15. The system of claim 10, wherein the management apparatus corresponds to at least one of:
a processor on the computer system;
a loghost computer system in a data center containing the computer system; and
a remote monitoring center for a set of data centers.

16. The system of claim 10, wherein the telemetric signals are further obtained using at least one of an operating system for the computer system and one or more external sensors.

17. A computer-readable storage medium storing instructions that when executed by a computer cause the computer to perform a method for analyzing telemetry data from a computer system, the method comprising:
obtaining the telemetry data as a set of telemetric signals using a set of sensors in the computer system; and
for each component or component location from a set of components in the computer system:
applying an inferential model to the telemetry data to determine an operating environment of the component or component location;
using the operating environment to assess a reliability of the component; and
managing use of the component in the computer system based on the assessed reliability.

18. The computer-readable storage medium of claim 17, wherein the inferential model is created by:
using a set of reference sensors to monitor a reference operating environment for a reference component in a test system, wherein the reference component corresponds to the component in the computer system;
stress-testing the test system over an operating envelope of the computer system; and
using a regression technique to develop the inferential model from the monitored reference operating environment.

19. The computer-readable storage medium of claim 17, wherein using the operating environment to assess the reliability of the component involves:
obtaining the operating environment as a set of stress metrics for the component;
adding the stress metrics to a cumulative stress history for the component; and
calculating a remaining useful life (RUL) of the component using the cumulative stress history.

20. The computer-readable storage medium of claim 19, wherein managing use of the component based on the assessed reliability involves at least one of:
generating an alert if the RUL drops below a threshold; and
using the assessed reliability to facilitate a maintenance decision associated with the component.
